(19) United States
(12) Patent Application Publication
(10) Pub. No.: US 2007/0084159 A1
(43) Pub. Date: Apr. 19, 2007

(54) Handle type cyclone dust-collecting apparatus

(75) Inventors: Jang-keun Oh, Gwangju-city (KR); Hak-bong Lee, Jeollanam-do (KR)

Correspondence Address: Paul D. Greeley;Ohlandt, Greeley, Ruggiero & Perle, L.L.P., 10th Floor, One Landmark Square, Stamford, CT, 06901-2682, US

(73) Assignee: SAMSUNG GWANGJU ELECTRONICS CO., LTD.

(21) Appl. No.: 11/473,837

(22) Filed: Jun. 23, 2006

(30) Foreign Application Priority Data
Oct. 19, 2005 (KR) 10-2005-0098760

(51) Int. Cl. B01D 50/00

(52) U.S. Cl. 55/337

(57) ABSTRACT

An handle type cyclone dust-collecting apparatus which is disposed at one side of an extension pipe of a vacuum cleaner. The handle type cyclone dust-collecting apparatus includes a connection body fluidly communicating with the extension pipe and having an air inlet port and an air outlet port, a dust-collecting casing detachably connected with the connection body, and a filter member disposed at the air outlet port to prevent dust particles from being flowing back to the air inlet port with air. The filter member includes a filter body and a conical skirt connected to a lower end of the filter body and having a cut-off part formed in a certain section thereof. A gap between a lower end of the skirt and an inner surface of the dust-collecting casing ranges from 4 mm to 6 mm.

### CROSS-REFERENCE TO RELATED APPLICATIONS

This application claims benefit under 35 U.S.C. § 119 from Korean Patent Application No. 2005-98760, filed Oct. 19, 2005, the entire content of which is incorporated herein by reference.

### BACKGROUND OF THE INVENTION

1. Field of the Invention

The present invention relates to a cyclone dust-collecting apparatus for a vacuum cleaner, and more particularly, to a handle type cyclone dust-collecting apparatus, which is disposed at one side of an extension pipe of a vacuum cleaner, for centrifugally separating out dust particles from drawn-in air.

2. Description of the Related Art

A cyclone dust-collecting apparatus rotates dust-entrained air drawn in through a suction brush of a vacuum cleaner and forms a whirling current, thereby separating out dust particles from the air by using a centrifugal force.

Recently, a handle type cyclone dust-collecting apparatus has been suggested. A general cyclone dust-collecting apparatus is disposed in a body of the vacuum cleaner to separate out dust particles from the drawn-in air and discharge cleaned air to the outside. However, it is theoretically impossible to completely separate out dust particles from the air. In attempt to solve this problem, the handle type cyclone dust-collecting apparatus has been developed. The handle type cyclone dust-collecting apparatus is mainly employed in a canister type vacuum cleaner, and it is disposed at one side of an extension pipe of the vacuum cleaner such that it can filter out the dust particles before the air drawn in through a suction brush flows into a cleaner body of the vacuum cleaner. A cyclone dust-collecting apparatus or a paper filter, which is disposed in the cleaner body, filters out small amount of dust particles and thus a dust-collection efficiency can be improved. Also, an overload exerted to a motor of the vacuum cleaner can be reduced.

The handle type dust-collecting apparatus comprises a filter member disposed on an air discharge outlet thereof and having a plurality of fine passing holes. The air is discharged from the handle type cyclone dust-collecting apparatus through the fine passing holes, whereas the dust particles are filtered out by the fine passing holes. However, if the dust particles clog the fine passing holes, a suction force of the vacuum cleaner deteriorates.

Korean Patent Publication No. 10-2000-47413 and British Patent Publication No. GB2402868 disclose a handle type cyclone dust-collecting apparatus having an improved structure to solve the above-mentioned problem. The disclosed handle type cyclone dust-collecting apparatus comprises a dust backflow prevention plate that is disposed at a lower end of the filter member to prevent dust particles from flowing back to the handle type cyclone dust-collecting apparatus. The dust backflow prevention plate prevents the backflow of the dust particles due to the ascending air current, and thus, the amount of dust particles to be filtered by the filter member can be decreased.

However, one problem with the dust backflow prevention plate is its relative inability to prevent backflow of fine dust particles. If the fine passing hole has a small size, the suction force of the vacuum cleaner is not smoothly transmitted. Therefore, the fine passing hole has to be designed to have a size sufficient to transmit the suction force smoothly. As a result, the fine dust particles may be attracted to the fine passing holes and, thus, they are likely to clog the filter member, which requires frequent replacement of the filter member.

Accordingly, a research for improving a fine dust particles collection efficiency is being progressed.

The handle type cyclone dust-collecting apparatus has many numbers of components, and in particular, has many number of components of a connection body to be connected to the extension pipe of the vacuum cleaner, which increases the number of assembling processes and causes a manufacturing cost to be increased.

### SUMMARY OF THE INVENTION

The present invention has been developed in order to solve the above problems in the related art. An aspect of the present invention is to provide a handle type cyclone dust-collecting apparatus having an improved structure to improve a fine dust particles collection efficiency.

Another aspect of the present invention is to provide a handle type dust-collecting apparatus which requires small number of assembling processes and achieves a cost-saving effect.

The above aspects and other advantages are achieved by providing an handle type cyclone dust-collecting apparatus which is disposed at one side of an extension pipe of a vacuum cleaner, comprising a connection body fluidly communicating with the extension pipe and having an air inlet port and an air outlet port, a dust-collecting casing detachably connected with the connection body, and a filter member disposed at the air outlet port to prevent dust particles from being flowing back to the air inlet port with air, wherein the filter member comprises a filter body and a conical skirt connected to a lower end of the filter body and having a cut-off part formed in a certain section thereof, and wherein a gap between a lower end of the skirt and an inner surface of the dust-collecting casing ranges from 4 mm to 6 mm.

The gap between the lower end of the skirt and the inner surface of the dust-collecting casing may be about 5 mm.

The connection body may comprise a first connection body fluidly communicating with a first extension pipe adjacent to a suction port of the vacuum cleaner and having the air inlet port; and a second connection body fluidly communicating with a second extension pipe adjacent to a body of the vacuum cleaner, an air discharge pipe downwardly protruding from the second connection body and having an air discharge port formed at a lower end of the air discharge pipe, and wherein the second connection body comprises an air guide member that is integrally formed with the air discharge pipe to enclose an outer circumference of the air discharge pipe and guides the air drawn in through the air inlet port to downwardly incline and move into the dust-collecting casing.

The dust-collecting casing may comprise a protrusion formed at an upper end thereof and press-fitted into a connection recess formed at a lower end of the first connection body, and a sealing member is fixed to an upper end of the protrusion to seal a connection portion between the protrusion and the connection recess.

The handle type cyclone dust-collecting apparatus may further comprise a rotation preventing rib formed at a lower portion of the dust-collecting casing and protruding from a center of the dust-collecting casing toward an inside surface of the dust-collecting casing, for preventing the dust particles from rotating due to a whirling current of the air.

### BRIEF DESCRIPTION OF THE DRAWINGS

These and/or other aspects of the present invention will become apparent and more readily appreciated from the following description of the embodiment, taken in conjunction with the accompanying drawings of which:

FIG. 1 is a perspective view illustrating a handle type cyclone dust-collecting apparatus according to an embodiment of the present invention;

FIG. 2 is an exploded perspective view illustrating the handle type cyclone dust-collecting apparatus of FIG. 1;

FIG. 3 is a bottom view illustrating a second connection body of FIG. 2;

FIG. 4 is a cross section view illustrating a connection portion for connecting the second connection body and a dust-collecting casing;

FIG. 5 is a plan view of the dust-collecting casing;

FIG. 6 is a plan view of a filter member disposed in the dust-collecting casing;

FIG. 7 is a graph showing dust-collection efficiency of the handle type cyclone dust-collecting apparatus employing the filter member according to an embodiment of the present invention and dust-collection efficiency of the conventional handle type cyclone dust-collecting apparatus; and

FIG. 8 is a cross section view of the handle type cyclone dust-collecting apparatus taken along the line VIII-VIII of FIG. 1 to explain the operation thereof.

### DETAILED DESCRIPTION OF AN EXEMPLARY EMBODIMENT

Hereinafter, a handle type cyclone dust-collecting apparatus according to an embodiment of the present invention will now be described with reference to the accompanying drawings.

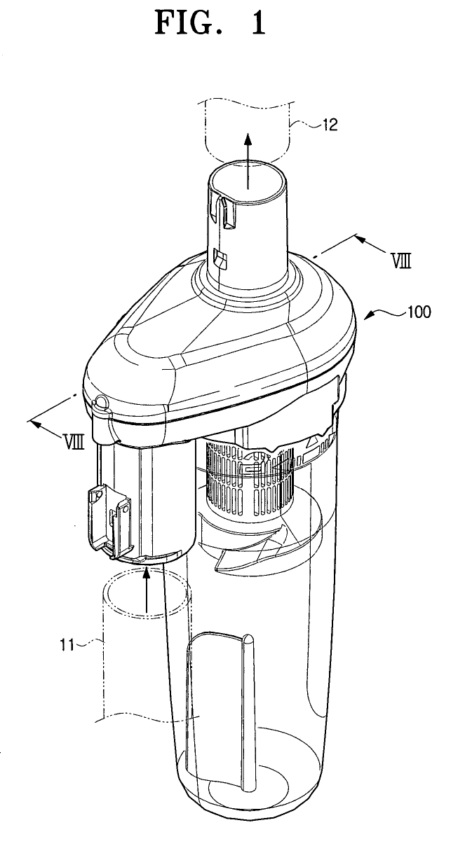

As shown in FIG. 1, a handle type cyclone dust-collecting apparatus 100 is connected to an extension pipe of a vacuum cleaner (not shown). The extension pipe includes a first extension pipe 11 connected to a suction brush (not shown) and a second extension pipe 12 connected to a cleaner body (not shown) provided with a suction force source. When the suction force source is driven by power supply, dust-entrained air is drawn into the handle type cyclone dust-collecting apparatus 100 through the suction brush (not shown) and the first extension pipe 11. The dust-removed air is discharged from the handle type cyclone dust-collecting apparatus 100 through the second extension pipe 12 and flows into the cleaner body (not shown).

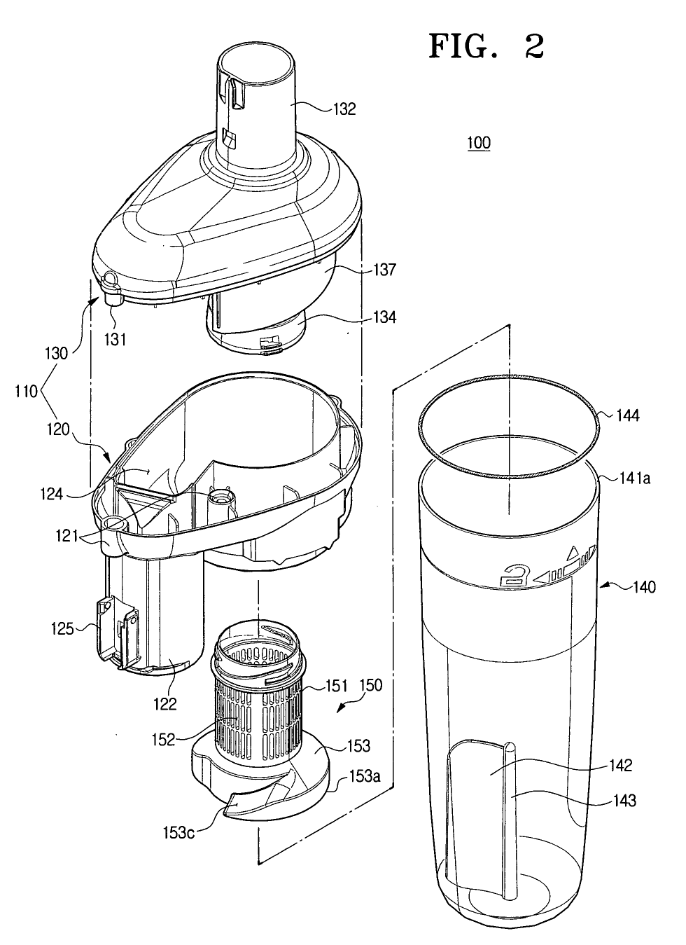

Referring to FIG. 2, the handle type cyclone dust-collecting apparatus 100 comprises a connection body 110 connected to the first and the second extension pipes 11, 12 to allow the air to flow in and out, a dust-collecting casing 140 detachably connected to the connection body 110, and a filter member 150 disposed in the dust-collecting casing 140.

The connection body 110 comprises a first connection body 120 fluidly communicating with the first extension pipe 11 and a second connection body 130 fluidly communicating with the second extension pipe 12. The first and the second connection bodies 120, 130 are fastened to each other by screws. For the screw-fastening, the first and the second connection bodies 120, 130 have a plurality of fixing bosses 121, 131, respectively, having screw holes and corresponding to each other. A dismounting protrusion or dismounting recess may be formed in the first and the second connection bodies 120, 130 to be connected with the first and the second extension pipes 11, 12, and, a corresponding dismounting recess or dismounting protrusion may be formed in the first and the second extension pipes 11, 12.

A first connection pipe 120 downwardly protrudes from the first connection body 120 to be connected with the first extension pipe 11, and an air inlet port 124 is formed in the first connection body 120 to fluidly communicate with the first connection pipe 122. The dust-collecting casing 140 is detachably connected with a lower end of the first connection body 120. An accessory bracket 125 is formed at an exterior of the first connection pipe 122 to mount and dismount an accessory part.

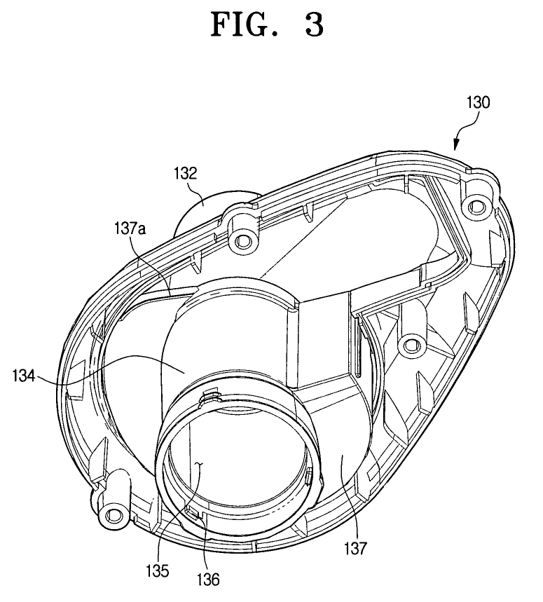

Referring to FIGS. 2 and 3, a second connection pipe 132 upwardly protrudes from the second connection body 130 to be connected with the second extension pipe 12. An air discharge pipe 134 downwardly protrudes from the second connection body 130 to fluidly communicate with the second connection pipe 132. The air discharge pipe 134 may be integrally formed with the second connection body 130. An air discharge port 135 is formed in a lower end of the air discharge pipe 134. Accordingly, the air separated out from dust particles in the dust-collecting casing 140 passes through the air discharge port 135 and the air discharge pipe 134 and is discharged through the second connection pipe 132. A plurality of connection protrusions 136 are formed around an inner surface of a lower end of the air discharge pipe 134 to be connected with the filter member 150.

An air guide member 137 is formed on an outer circumference of the air discharge pipe 134. The air guide member 137 may be integrally formed with the air discharge pipe 134. As described above, since the air discharge pipe 134 and the air guide member 137 are integrally formed with the second connection body 130, the number of assembly processes of the handle type cyclone dust-collecting apparatus 100 decreases, which reduces a manufacturing cost.

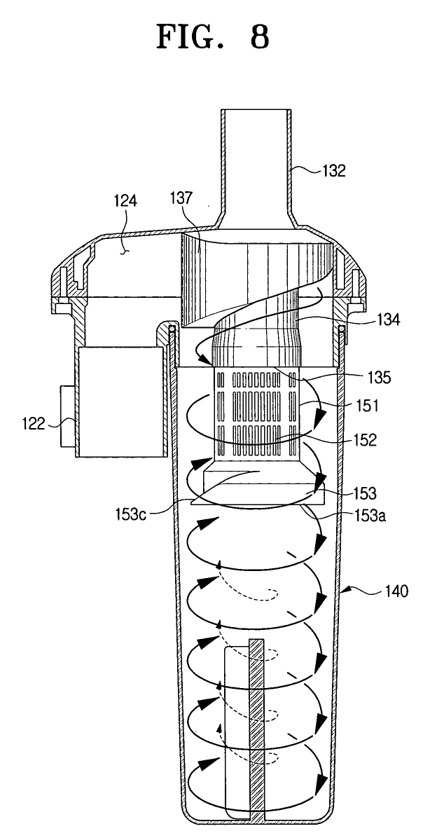

The air guide member 137 has a width gradually increasing toward a lower portion and continuously encloses the outer circumference of the air discharge pipe 134. The air guide member 137 is in the shape of a unfilled duct or a filled wall. If the air guide member 137 is in the shape of the unfilled duct, the air is guided into the unfilled duct, and if the air guide member 137 is in the shape of the filled wall, the air is guided to the bottom. The air guide member 137 has one end 137a fluidly communicating with the air inlet port 124. Accordingly, the air drawn in through the air inlet port 124 is guided by the air guide member 137 and flows into the dust-collecting casing 140, while forming a spiral air current downwardly advancing (see FIG. 8). As the air flows into the dust-collecting casing 140 by being guided by the air guide member 137, its swirling current increases and thus maximizes a centrifugal force exerted to the dust particles included in the air. Accordingly, the dust particles are separated out from the air very effectively and a dust-collection efficiency can be improved.

In a conventional handle type cyclone dust-collecting apparatus, air flows into a dust-collecting case and thereby forms a swirling current. However, an inclination of the air is slight, which results in a weaker swirling force. According to the present invention, the air guide member 137 maximizes a swirling force of the air flowing into the dust-collecting casing 140, thereby improving a dust-collection efficiency.

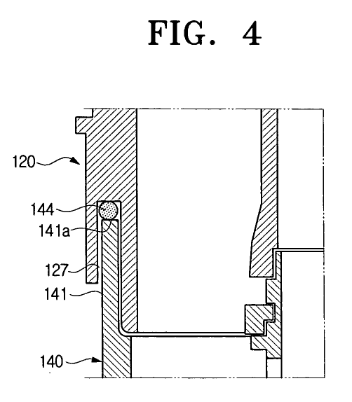

FIG. 4 is a cross section of a connecting portion between the dust-collecting casing 140 and the first connection body 120. Referring to FIGS. 2 and 4, the dust-collecting casing 140 is detachably connected with the first connection body 120. The dust-collecting casing 140 is connected with the first connection body 120 to allow the drawn-in air to be rotated and to form a whirling current. The dust particles separated out from the air by a centrifugal force generated by the whirling current are collected in the dust-collecting casing 140. A protrusion 141 is formed on an upper end of the dust-collecting casing 140 and press-fitted into a connection recess 127 formed in a lower portion of the first connection body 120. An annular sealing member 144 is fixed to an upper end 141a of the protrusion 141 by adhesive. The sealing member 144 is made of various materials, and preferably, made of rubber material. The sealing member 144 seals the connection portion between the upper end 141a of the protrusion 141 and the connection recess 127.

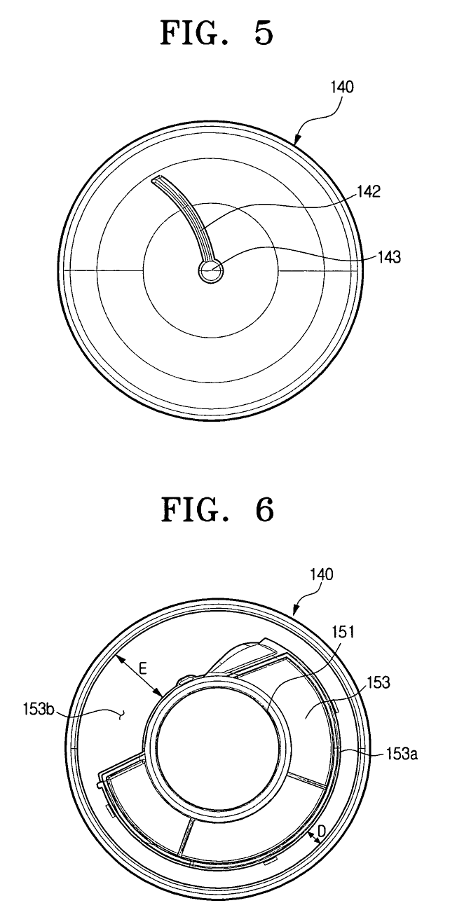

Referring to FIGS. 2 and 5, a rotation preventing rib 142 is disposed inside the dust-collecting casing 140. The rotation preventing rib 142 protrudes from a supporting shaft 143. The rotation preventing rib 142 has a curved surface to reduce a friction against air. The rotation prevention rib 142 prevents the dust particles stacked in the dust-collecting casing 140 from being rotated by the whirling current of the air. More specifically, the rotation preventing rib 142 prevents the dust particles stacked on the bottom of the dust-collecting casing 140 from being scattered. In addition, the rotation preventing rib 142 compresses the dust particles such that larger amount of dust particles can be collected in the dust-collecting casing 140.

Referring to FIGS. 2 and 6, the filter member 150 is inserted into the dust-collecting casing 140 to prevent the dust particles from flowing back to the air inlet port 124 through the air guide member 124 together with the air discharged through the air discharge port 135 (see FIG. 3). The filter member 150 comprises a filter body 151 and a skirt 153.

An upper end of the filter body 151 is connected with a lower end of the air discharge pipe 134 (see FIG. 3) having the air discharge port 135, and the filter body 151 is directed toward a lower side of the air discharge pipe 134 and extends toward the inside of the dust-collecting casing 140. A plurality of fine passing holes 152 are formed on the filter body 151 to allow the air to pass therethrough. The skirt 153 has an upper end connected to the lower end of the filter body 151 and is in a conical shape to have a diameter gradually increasing toward a lower end 153a. A cut-off part 153b is formed in a certain section of the skirt 153. Relatively large dust particles, separated out from the air, drop down to the bottom of the dust-collecting casing 140 through the cut-off part 153b.

The skirt 153 forms an inclined part 153c downwardly inclined and adjacent to the cut-off part 153b, so that air and dust drawn in the dust-collecting casing 140 can be smoothly guided towards the bottom of the dust-collecting casing. The inclined part 153c may be inclined toward the direction corresponding to a flow of air swirling downward.

A gap ‘D’ between an edge of the lower end 153a of the skirt 153 and the inner surface of the dust-collecting casing 140 is from 4 mm to 6 mm, and more preferably, is about 5 mm. In the conventional handle type cyclone dust-collecting apparatus, a gap D is about 8 mm. That is the gap D is smaller than that of the conventional apparatus such that the fine dust particles stacked on the bottom of the dust-collecting apparatus are prevented from flowing back through the gap D. If the gap D is narrower than 4 mm, a suction force is not smoothly transmitted. A gap ‘E’ between the edge of the lower end 153b of the skirt 153 at the cut-off part 153b and the inner surface of the dust-collecting casing 140 is about 12 mm (millimeters).

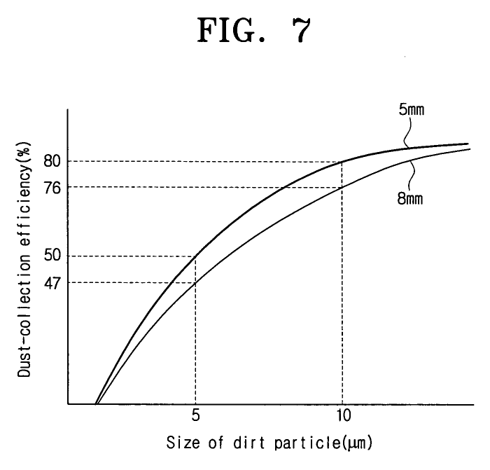

FIG. 7 is a graph showing a fine dust particles collection efficiency of the handle type cyclone dust-collecting apparatus according to an embodiment of the present invention, which has the gap D of about 5 mm, and a fine dust particles collection efficiency of the conventional handle type cyclone dust-collecting apparatus, which has the gap D of about 8 mm. If the size of dust particle is about 5 μm (micrometers), the conventional apparatus, which has the gap of about 8 mm, has a dust collection efficiency of 47%, and the handle type cyclone dust-collecting apparatus according to an embodiment of the prevent invention, which has the gap D of about 5 mm, has a dust-collection efficiency of 50%. If the size of the dust particles is about 10 μm, the conventional apparatus has a dust-collection efficiency of 76% and the handle type cyclone dust-collecting apparatus according to an embodiment of the present invention has a dust-collection efficiency of 80%. According to the present invention, the dust-collection efficiency of the dust particle below 10 μm is improved by 5% compared to that of the conventional apparatus. If the dust particles is larger than 10 μm, there is no noticeable improvement in dust-collection efficiency between the present invention and the related art.

Hereafter, operation of the handle type cyclone dust-collecting apparatus 100 according to an embodiment of the present invention will now be described in detail.

When a power is supplied, a suction force is generated by the driving of a suction force source (not shown) mounted in the cleaner body such that dust-entrained air is drawn in through the suction brush (not shown) and flows into the air inlet port 124 through the first connection pipe 122. The drawn-in air is downwardly inclined by the air guide member 137 and flows into the dust-collecting casing 140. The air descends, forming a whirling current. During this process, the dust particles are concentrated toward the inner wall of the dust-collecting casing 140 and descend along the inner wall, thereby being collected on the bottom of the dust-collecting casing 140. Then, the air changes its direction, moves up, passes between the lower end 153a of the skirt 153 and the inner surface of the dust-collecting casing 140, passes through the fine passing holes 152 of the filter body 151, and then is discharged through the air discharge port 135. At this time, the dust particles included in the ascending air are filtered by the lower end 153a of the skirt 153 and the filter body 151 such that the dust particles move down and are collected on the bottom of the dust-collecting casing 140. The air discharged through the air discharge port 135 escapes from the handle type cyclone dust-collecting apparatus 100 through the air discharge pipe 134 and the second connection pipe 132 and flows into the cleaner body (not shown). The vacuum cleaner performs the same dust-collecting operation as that of a general vacuum cleaner.

According to the present invention as described above, since the handle type cyclone dust-collecting apparatus 100 has a gap between the lower end 153a of the skirt 153 of the filter member 150 and the dust-collecting casing 140 shorter than that in the related art, fine dust particles can be prevented from being scattered and thus backflow thereof can be prevented. Accordingly, a fine dust particle collection efficiency is improved.

Also, since the air guide member 138, which is the downward spiral shape, is integrally formed with the connection body 110, the number of assembly parts is reduced and thus a cost-saving effect is achieved. Also, it is possible to increase a whirling force of the air flowing into the dust-collecting casing 140, which maximizes a centrifugal force.

Also, since the sealing member 144 is inserted to the upper end of the dust-collecting casing 140, an air-tightness is increased.

Also, since the rotation preventing rib 142 is disposed under the dust-collecting casing 140, the dust particles are prevented from being scattered and are compressed, which results in the improvement of the dust collection efficiency.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. An handle type cyclone dust-collecting apparatus which is disposed at one side of an extension pipe of a vacuum cleaner, comprising:
a connection body for fluidly communicating with the extension pipe, the connection body having an air inlet port and an air outlet port;
a dust-collecting casing detachably connected with the connection body; and
a filter member disposed at the air outlet port to prevent dust particles from flowing back to the air inlet port with air,
wherein the filter member comprises a filter body and a conical skirt connected to a lower end of the filter body and having a cut-off part formed in a certain section thereof, and
wherein a gap between a lower end of the skirt and an inner surface of the dust-collecting casing ranges from 4 mm to 6 mm.

2. The handle type cyclone dust-collecting apparatus as claimed in claim 1, wherein the skirt forms an inclined part downwardly inclined and adjacent to the cut-off part, so that air and dust drawn in the dust-collecting casing can be smoothly guided towards a bottom of the dust-collecting casing.

3. The handle type cyclone dust-collecting apparatus as claimed in claim 1, wherein the inclined part may be inclined toward a direction corresponding to a flow of air swirling downward.

4. The handle type cyclone dust-collecting apparatus as claimed in claim 1, wherein the gap between the lower end of the skirt and the inner surface of the dust-collecting casing is about 5 mm.

5. The handle type cyclone dust-collecting apparatus as claimed in claim 1, wherein the connection body comprises a first connection body for fluidly communicating with a first extension pipe adjacent to a suction port of the vacuum cleaner, the first connection body having the air inlet port; and a second connection body for fluidly communicating with a second extension pipe adjacent to a body of the vacuum cleaner, the second connection body having an air discharge pipe downwardly protruding therefrom and having an air discharge port formed at a lower end of the air discharge pipe, and
wherein the second connection body comprises an air guide member that is integrally formed with the air discharge pipe to enclose an outer circumference of the air discharge pipe, the air guide member guiding the air drawn in through the air inlet port to downwardly incline and move into the dust-collecting casing.

6. The handle type cyclone dust-collecting apparatus as claimed in claim 1, wherein the dust-collecting casing comprises a protrusion formed at an upper end thereof, the protrusion being press-fitted into a connection recess formed at a lower end of the first connection body, and the dust-collecting casing comprising a sealing member fixed to an upper end of the protrusion to seal a connection portion between the protrusion and the connection recess.

7. The handle type cyclone dust-collecting apparatus as claimed in claim 1, further comprising a rotation preventing rib formed at a lower portion of the dust-collecting casing and protruding from a center of the dust-collecting casing toward an inside surface of the dust-collecting casing, the rotation preventing rib preventing the dust particles from rotating due to a whirling current of the air.
